(19) United States
(12) Patent Application Publication
(10) Pub. No.: US 2016/0037217 A1
(43) Pub. Date: Feb. 4, 2016

(54) Curating Filters for Audiovisual Content

(71) Applicant: VidAngel, Inc., Provo, UT (US)

(72) Inventors: Neal Harmon, Provo, UT (US); Benton Crane, Provo, UT (US); Jordan Harmon, Burley, ID (US)

(73) Assignee: VidAngel, Inc., Provo, UT (US)

(21) Appl. No.: 14/621,972

(22) Filed: Feb. 13, 2015

Related U.S. Application Data
(60) Provisional application No. 61/941,228, filed on Feb. 18, 2014.

(51) Int. Cl. H04N 21/4545; H04N 21/45; H04N 21/84; H04N 21/845; H04N 21/454; H04N 21/475; H04N 21/262; H04N 21/234; H04N 21/2668; H04N 21/658; H04N 7/16

(52) U.S. Cl. CPC H04N 21/45457; H04N 21/6582; H04N 21/4532; H04N 21/84; H04N 21/8456; H04N 7/162; H04N 21/4755; H04N 21/26283; H04N 21/23418; H04N 21/2668; H04N 21/4542

(57) ABSTRACT

A method and system for collaboratively curating video maps used for filtering audio, visual, or audiovisual content, such as a movie. One or more video taggers may tag segments of a movie containing filterable content, such as swearing, nudity, sex, violence, etc. A tag for a segment containing filterable content may comprise a start time, an end time, and a reference to one or more categories of filterable content, e.g., swearing, nudity, sex, etc. A video reviewer may review the quality of a tagger's work, and may add, delete, or edit tags, and may also send the video back to the tagger for further work. A video publisher may further review the tagger's and the reviewer's work and add, delete, or edit tags; send the video back to the reviewer or tagger for further work; or publish the tags as a “video map” which may be used with a user filter (or user preferences) to filter a movie. A user's preferences may indicate which categories of content the user wishes to remove from a movie, e.g., nudity and violence, and which categories the user wishes to keep in the movie, e.g., swearing. A user may then view the movie, filtered, based on his preferences and the video map. The user may provide feedback or a rating on the quality of the video map, which may be used for further tagging by a tagger, reviewer, or publisher. The preparation of a video map through tagging, reviewing, publishing, and user-reviewing may be iterative.

This application claims priority to Provisional Application No. 61/941,228 filed on Feb. 18, 2014.

### BACKGROUND OF THE INVENTION

The present disclosure relates to technology for curating filters for audiovisual content.

Users are increasingly turning to the Internet for their entertainment needs. In recent years, online content providers like YouTube™, Netflix™, and Amazon Prime Instant Video™ have experienced explosive growth due to user demand for streaming of multimedia content. Many online content providers now offer unlimited streaming of the digital content they provide. Users can also rent movies online and stream the content on-demand to their consumption devices, such as smartphones, tablets, laptops, Internet-enabled televisions, etc.

These online content providers generally do not, however, provide users with a way to personalize the playback of the content, such as suppressing mature or otherwise offensive content that is often present in offered multimedia content. Some hardware solutions, e.g., specialized DVD players, enable personalized playback of movies, as allowed by the Family Entertainment and Copyright Act, but these solutions suffer from multiple shortcomings: they are limited to DVD playback, they require users to purchase expensive dedicated hardware, and they do not allow users to collectively curate filters for the audiovisual content, among other things.

Further, tagging a movie to identify filterable content can be burdensome and time consuming. What is needed is a way for groups, or communities, to collaborate in tagging movies and other content, and also a way to curate collaboratively prepared movie tagging, i.e., to audit and ensure the quality of collaboratively prepared movie tagging.

### BRIEF SUMMARY OF THE INVENTION

This application discloses a filter curation platform that enables users to curate and access custom filters that are usable to adapt the playback of audiovisual content.

In one embodiment, video tags may be prepared for a movie or other audio, visual, or audiovisual content. A video tag may identify a start time and a stop time of segment for possible filtering, and may further identify one or more categories of filterable content associated with the identified segment. A video map is a collection of one or more video tags for a particular movie, and effectively tags segments of filterable content in the movie.

A video viewer, via a media player interface may define filters using a video map of a movie. The video viewer may customize the filter to display (or make audible) some categories or specific segments of filterable content, but not others.

The disclosed curation platform may enable users, which may have different roles, to create one or more video tags for a movie, and thereby and create a full or partial video map for the movie. Roles may include video viewer, video tagger, video reviewer, and video publisher.

A video tagger is a user who may create video maps for audiovisual content. A video reviewer is a user who may review video maps for mistakes, make corrections, and provide feedback on the video maps created by video taggers. A video publisher is a user who may prepare, finalize, and publish video maps to a multimedia portal.

The video-tagging process may be collaborative and iterative. For example, multiple video taggers may tag the same portions of a movie, and a video reviewer may access the video maps from the multiple video taggers. In another embodiment, a video reviewer may review a video map created by a video tagger and send the video map to a different video tagger for further tagger. The process may be iterative in many ways, so that multiple video taggers, video reviewers, and video publishers may prepare, review, edit, and pass among each other video maps in various orders and workflows.

Video viewers, taggers, reviewers, and publishers may assign scores to video tags and/or video maps, reflective of the quality of a video tag or video map. The disclosed curation process may also employ an incentive system to motive users with various roles to perform their roles quickly and with high quality.

The curation system disclosed herein may further be configured to automatically generate video tags and video maps.

### BRIEF DESCRIPTION OF THE DRAWINGS

FIG. 1A is an exemplary interface for creating a filter.

FIG. 1B is an exemplary interface for creating a filter.

FIG. 1C is an exemplary interface for viewing content, providing feedback on tagging, or adjusting a filter.

FIG. 1D a graphical representation of example video and audio lineups of an example user-customized filter.

FIG. 2 is an interface displaying the progress of tagging for several movies.

FIG. 3 is an interface of a dashboard for accessing tagging and filtering features of the curation platform disclosed herein.

FIG. 4A is an interface of a dashboard showing audiovisual content waiting to be published.

FIG. 4B is an interface for adding a file to the video catalog of the curation platform disclosed herein, or for editing the settings of the file.

FIG. 5A is an interface associated tagging, reviewing, and publishing.

FIG. 5B is an interface associated with publishing.

FIG. 5C is an interface associated with reviewing the quality of tagging work.

FIG. 6 is an exemplary media portal interface.

FIG. 7 is an exemplary curation system as disclosed herein.

FIG. 8A is an exemplary computing system that may be used in conjunction with the curation system disclosed herein.

FIG. 8B is an exemplary datastore that may be used in conjunction with the curation system disclosed herein.

FIG. 9 is an exemplary embodiment of a client device that may be used in conjunction with the curation system disclosed herein.

FIG. 10A is a flowchart of an exemplary curation process as disclosed herein.

FIG. 10B is a flowchart of an alternative exemplary curation process as disclosed herein.

FIG. 11 is a flowchart illustrating, in one embodiment, the iterative nature of the curation process disclosed herein.

### DETAILED DESCRIPTION OF THE INVENTION

This application discloses a filter curation platform that enables users to curate and access custom filters that are usable to adapt the playback of audiovisual content.

Audiovisual content, as referred to herein, includes any audiovisual content available via a computer network, e.g., the Internet. It should be understood that the technology herein is applicable also to other forms of media including streaming audio and stored audio and/or video (e.g., read from a non-transitory physical medium such as a hard drive, flash memory, CD, DVD, Blu-ray™, etc.). In some embodiments, servers of various content providers may host the audiovisual content and stream it in real-time to the client devices of various users via the network. YouTube™ is an exemplary content provider. The audiovisual content may be freely available or may be paid content requiring a user account and/or a rental, subscription, or purchase to access.

In some embodiments, the technology facilitates a process for curating user-defined filters for digital audiovisual content. The audiovisual content may be embodied by a multimedia file that includes audio and/or visual content. Audio content (or audio for short) includes only content that is audible during playback. Visual content (or video for short) includes content that is audible and visual, or just visual, during playback.

A video tag (also referred to as a VidTag) is a short description of a segment/clip of a multimedia file. A video tag includes a type, start time, end time, and a category. Examples of the different types of video tags include audio, video, and audiovisual, in which audio refers to audio content, video refers to the video content, and audiovisual refers to both the audio and the video content. A video tag start time refers to the start time of the segment relative to the total time of the multimedia file, and an end time refers to the end time of the segment relative to the total time of the multimedia file. In alternate embodiments, a video tag start time or end time may be relative to a time other than the total time of the multimedia file, as long as the video tag start time or stop time identifies the beginning or ending, respectively, of a segment. Examples of video tag categories may include positive and negative categories, such as Action, Dramatic, Scary, Alcohol/Drugs, Profane/Crude Language, Sex/Nudity, Violence, Other (e.g., Negative, Positive) Elements, etc.

A video map (also referred to as a VidMap) is a collection of video tags that describe the content of a multimedia file. It is analogous to a review of the multimedia file content. In some embodiments, a user, via a media player interface (also referred to as a VidPlayer), may define filters using a video map of the multimedia file displayed via the VidPlayer.

The curation platform may use different user roles to curate the custom filters, such as, but not limited to, a video viewer (also referred to as a VidViewer), a video tagger (also referred to as a VidTagger), a video reviewer (VidReviewer), and a video publisher (VidPublisher). A video viewer is a user who can access video maps and create filters to use during playback of audiovisual content. For instance, a video viewer may create various filters on a per-show basis by referring to the video map associated with the show and defining filter settings from his own selection of video tags. In some embodiments, any user may act as a video viewer.

A video tagger is a user who may create video maps for audiovisual content. A video reviewer is a user who may review video maps for mistakes, make corrections, and provide feedback on the video maps created by video taggers. A video publisher is a user who may prepare, finalize, and publish video maps to a multimedia portal, such as the portals accessible at www.vidangel.com, www.youtube.com, etc. In some embodiments, a user must be granted authorization (e.g., by an administrator of the curation platform) before acting in the role of video viewer, video tagger, video reviewer, and video publisher. For instance, the roles various users have been granted may be stored in a user profile associated with the user in the data store of the curation system, and may be referenced during the user login to determine if the user is authorized to act in that role.

A user may access the multimedia portal to consume different audiovisual content (e.g., movies, shows, etc.) via a media player provided by the portal, such as an embedded media player capable of playing back the audiovisual content. The media player may be configured (e.g., using an API) to reference the video map created using the curation platform and augment the playback based on the filters defined by the user.

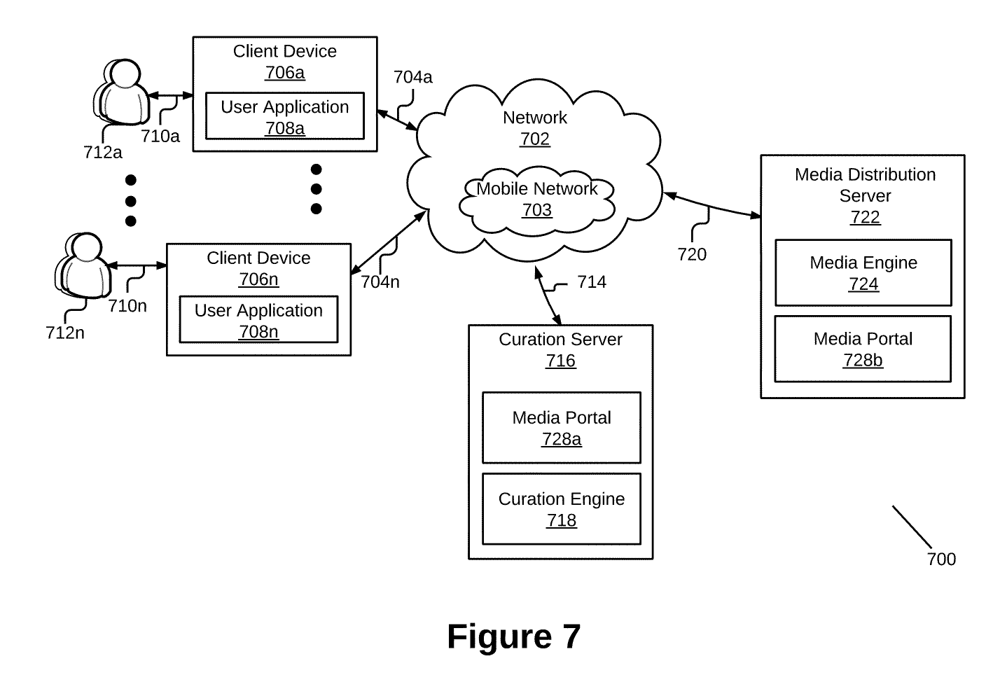

FIG. 7 is a block diagram illustrating an example curation system 700. Curation system 700 includes client devices 706a . . . 706n, a curation server 716, and a media distribution server 722, which are communicatively coupled via a network 702 for interaction with one another. For example, client devices 706a . . . 706n may be respectively coupled to network 702 via signal lines 704a . . . 704n and may be accessible by users 712a . . . 712n (also referred to individually and collectively as 712) as illustrated by lines 710a . . . 710n. Curation server 716 may be coupled to network 702 via signal line 714. Media distribution server 722 may be coupled to the network 702 via signal line 720. The use of the nomenclature “a”, “b,” . . . “n” in the reference numbers indicates that any number of those elements having that nomenclature may be included in system 700.

Network 702 may include any number of networks and/or network types. For example, network 702 may include, but is not limited to, one or more local area networks (LANs), wide area networks (WANs) (e.g., the Internet), virtual private networks (VPNs), mobile (cellular) networks (e.g., the mobile network 103), wireless wide area network (WWANs), WiMAX® networks, Bluetooth® communication networks, peer-to-peer networks, other interconnected data paths across which multiple devices may communicate, various combinations thereof, etc. Data transmitted by network 702 may include packetized data (e.g., Internet Protocol (IP) data packets) that is routed to designated computing devices coupled to network 702. In some implementations, network 702 may include a combination of wired and wireless networking software and/or hardware that interconnects the computing devices of system 700. For example, network 702 may include packet-switching devices that route the data packets to the various computing devices based on information included in a header of the data packets.

Mobile network 703 may include a cellular network having distributed radio networks and a hub. In some implementations, client devices 706a . . . 706n may send and receive signals to and from a transmission node of mobile network 703 over one or more of a control channel, a voice channel, a data channel, etc. In some implementations, one or more client devices 706a . . . 706n may connect to network 702 via a wireless wide area network (WWAN) of mobile network 703. For instance, mobile network 703 may route the network data packets sent and received by client device 706a to the other entities 706n, 716, 722, 730, and/or 734 that are connected to network 702 (e.g., via a the Internet, a VPN, etc.). Mobile network 703 and client devices 706 may use a multiplexing protocol or a combination of multiplexing protocols to communicate, including, for example, FDMA, CDMA, SDMA, WDMA, or any derivative protocols, etc. Mobile network 703 and client devices 706 may also employ multiple-input and output (MIMO) channels to increase the data throughput over the signal lines coupling mobile network 703 client devices 706. Mobile network 703 may be any generation mobile phone network. In some instances, mobile network 702 maybe a 2 G or 2.5 G GSM, IS-95, etc., network; a 3 G UTMS, IS-2000, etc., network; a 4 G HSPA+, 3GPP LTE, WiMAX™, etc., network; etc. In some instances, mobile network 703 may include a backwards-compatible multi-generational network that supports two or more technology standards.

Client devices 706a . . . 706n (also referred to individually and collectively as 106) are computing devices having data processing and communication capabilities. In some embodiments, a client device 706 may include a processor (e.g., virtual, physical, etc.), a memory, a power source, a network interface, and/or other software and/or hardware components, such as a display, graphics processor, wireless transceivers, keyboard, camera, sensors, firmware, operating systems, drivers, various physical connection interfaces (e.g., USB, HDMI, etc.). Client devices 706a . . . 706n may couple to and communicate with one another and the other entities of system 700 via network 702 using a wireless and/or wired connection.

Examples of client devices 706 may include, but are not limited to, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. While two or more client devices 706 are depicted in FIG. 7, system 700 may include any number of client devices 706. In addition, client devices 706a . . . 706n may be the same or different types of computing devices.

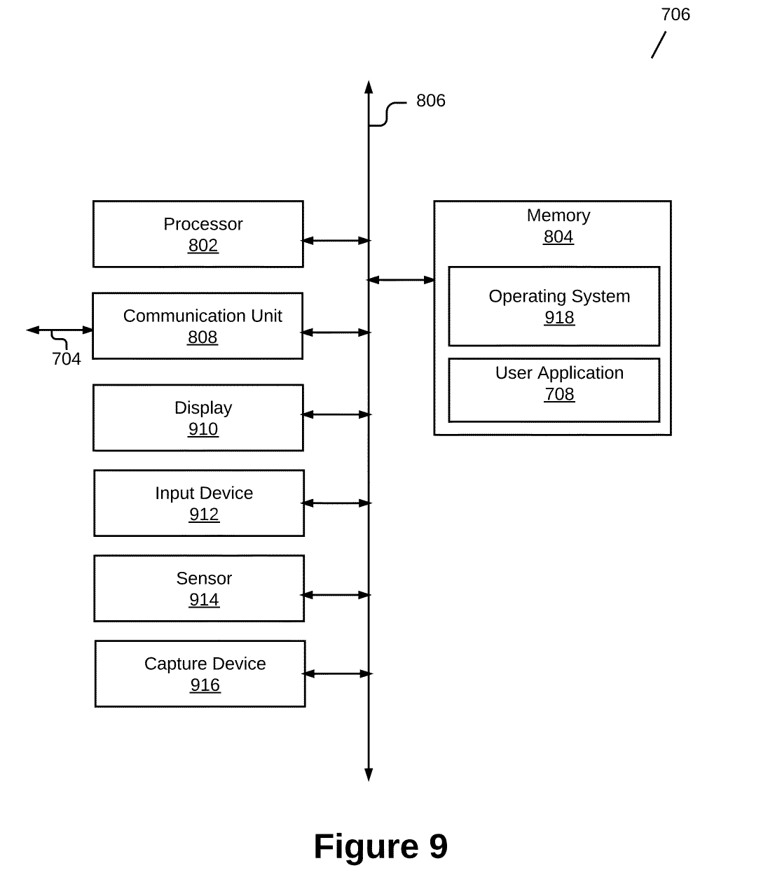

In the depicted implementation, client devices 706a . . . 706n respectively contain instances 708a . . . 708n of a user application (also referred to individually and collectively as 708). User application 708 may be storable in a memory 804 (e.g., see FIG. 9) and executable by a processor 802 (e.g., see FIG. 9) of a client device 706 to provide for user interaction, receive user input, present information to the user via a display (e.g., see FIG. 9), and send data to and receive data from the other entities of system 700 via network 702. User application 708 may be operable to allow users to consume personalized audiovisual content, curate video maps, tags, filters, etc., collaborate, provide feedback, view and update their accounts, track earnings and credits earned through curation efforts, browse content available via the Internet, and perform other acts.

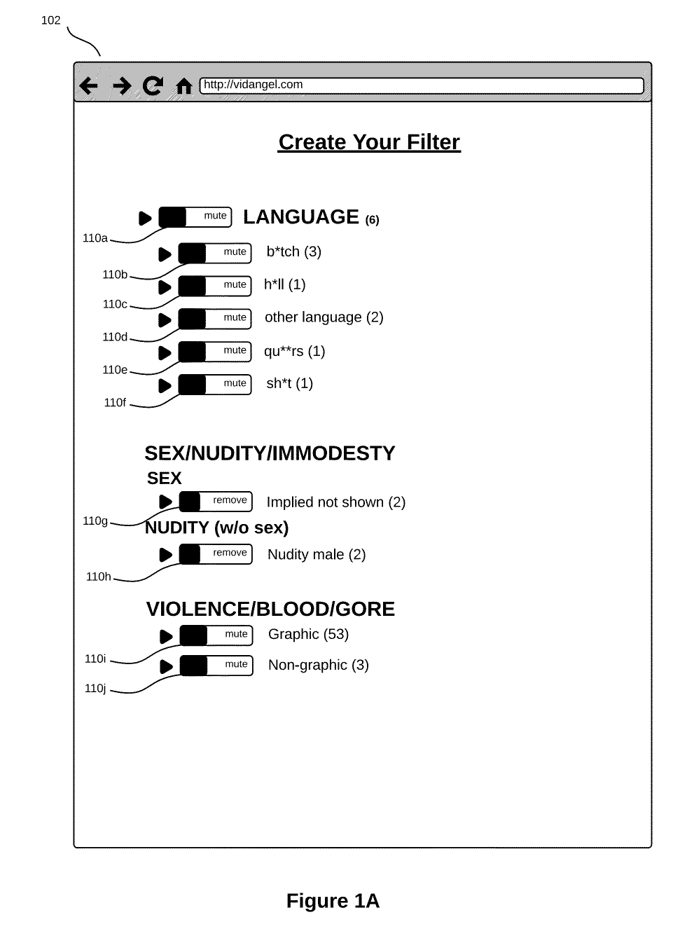

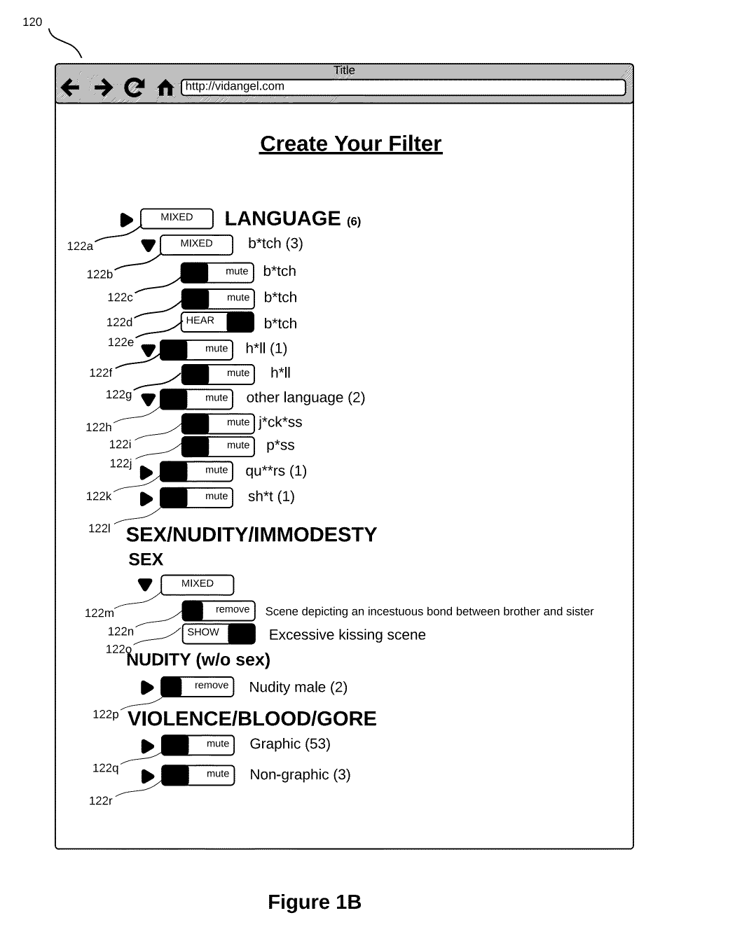

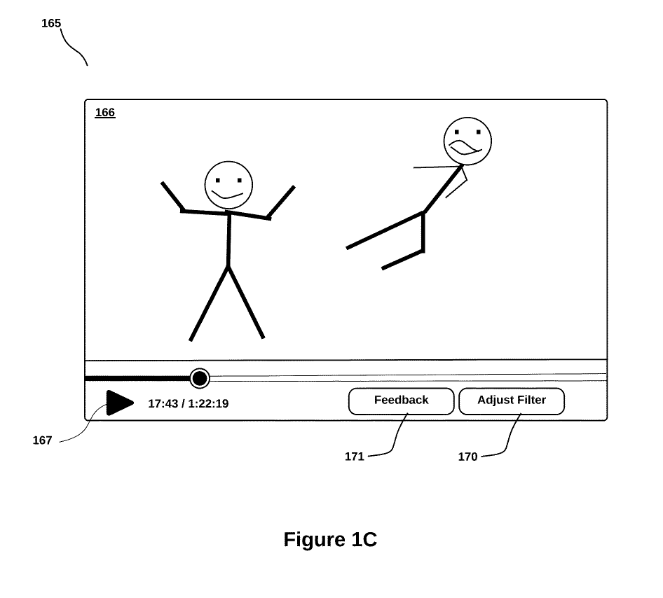

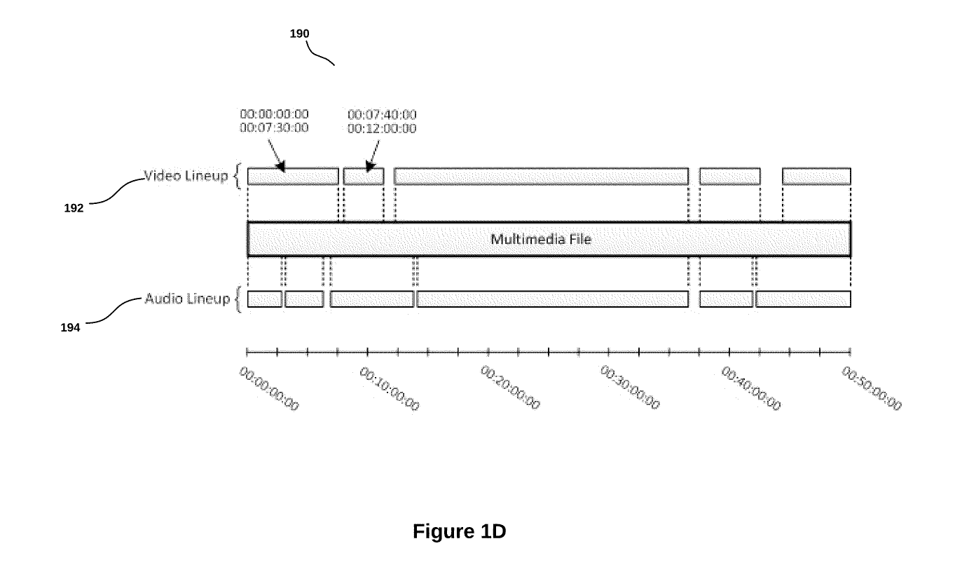

In some implementations, user application 708 may generate and present various user interfaces for performing various acts and/or functionality, which may in some cases be based at least in part on information received from the curation server, and/or media distribution server 722, etc., via network 702. In some implementations, user application 708 is code operable in a web browser, a native application (e.g., a mobile app), a combination of both, etc. Example interfaces that can be rendered and displayed by the user application 708 are depicted in FIGS. 1A-D and 2-6. Additional structure and functionality of client devices 706 and user application 708 are described in further detail below with reference to at least FIG. 9.

FIG. 1A illustrates an exemplary interface 102 for creating a filter. Using toggles 110a-j, a user may determine which content he wants to filter (“mute” or “remove”) settings.

FIG. 1B illustrates an exemplary interface 120 for creating a filter, in which a user may use toggles 122a-r to determine which content he wants to filter. For example, in interface 120, the toggles set to “mute” and “remove” indicate that a user has selected to filter associated content. The toggles set to “HEAR” and “SHOW” indicate that a user has selected to not filter associated content.

FIG. 1C illustrates an exemplary interface 165 for viewing content, providing feedback on tagging, or adjusting a filter. Interface 165 includes a display 166, playback control 167, and buttons 170 and 171 for providing feedback on tagging or for adjusting a filter.

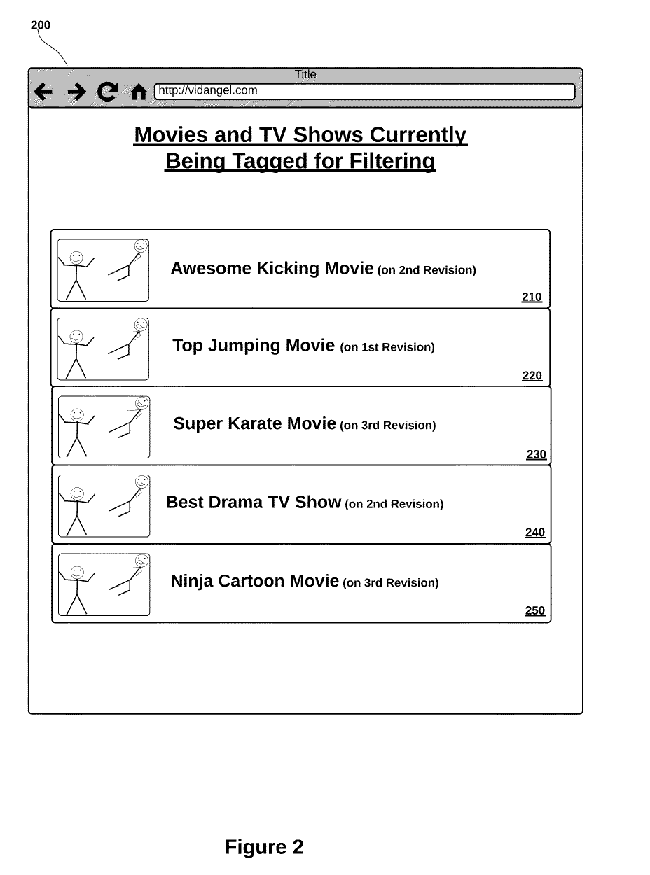

FIG. 2 illustrates an exemplary interface 200 for displaying the progress of tagging for several movies. Entries 210, 220, 230, 240, and 250 illustrate entries for five separate movies, and indicate that the tagging process for these five movies is “on 2nd Revision,” “on 1st Revision,” “on “3rd Revision,” “on 2nd Revision,” and “on 3rd Revision,” respectively.

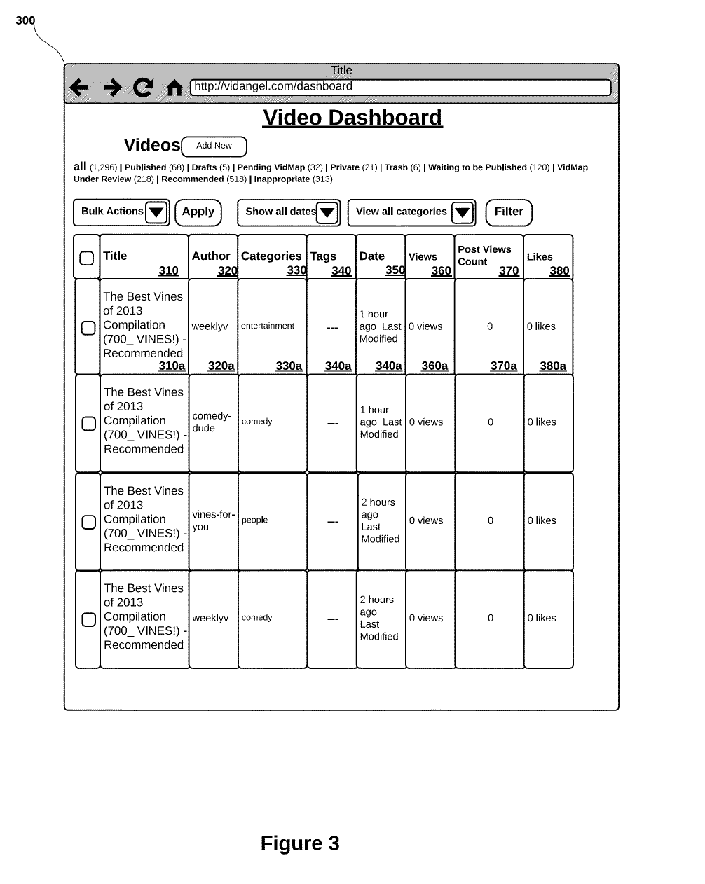

FIG. 3 illustrates an interface 300 of a dashboard for accessing tagging and filtering features of the curation platform disclosed herein. Columns 310, 320, 330, 340, 350, 360, 370, and 380 may identify the title of a movie or other video content, the author or source of the video, the categories or genre of the video, tags associated with the video, the date the video was last tagged, the number of times a video has been viewed, the number of post views, and the number of times a video has been “liked.”

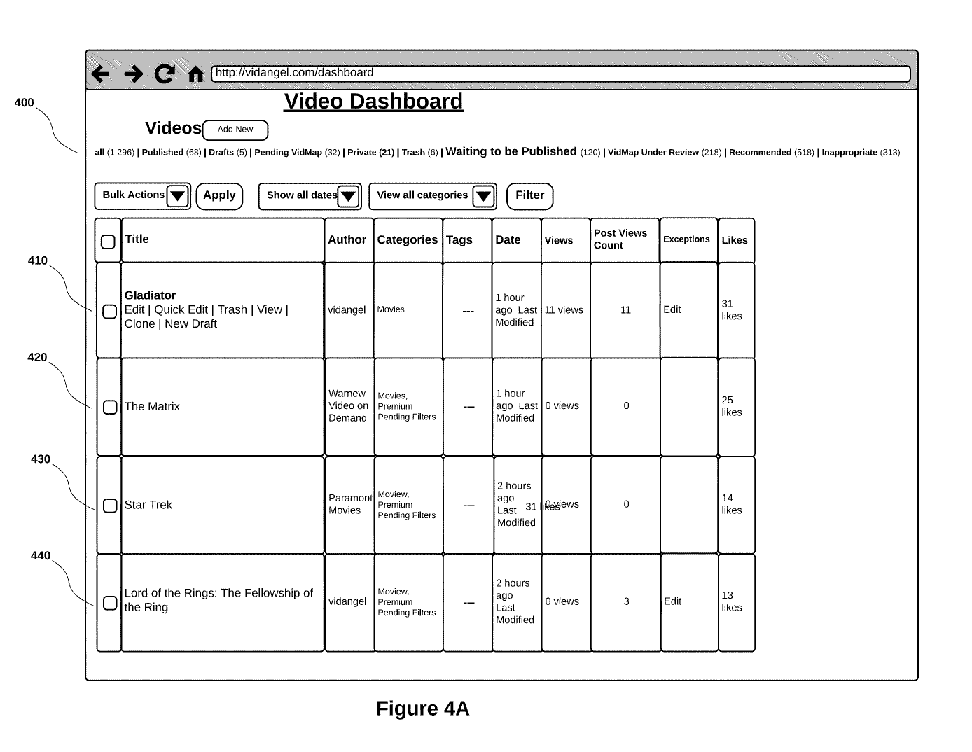

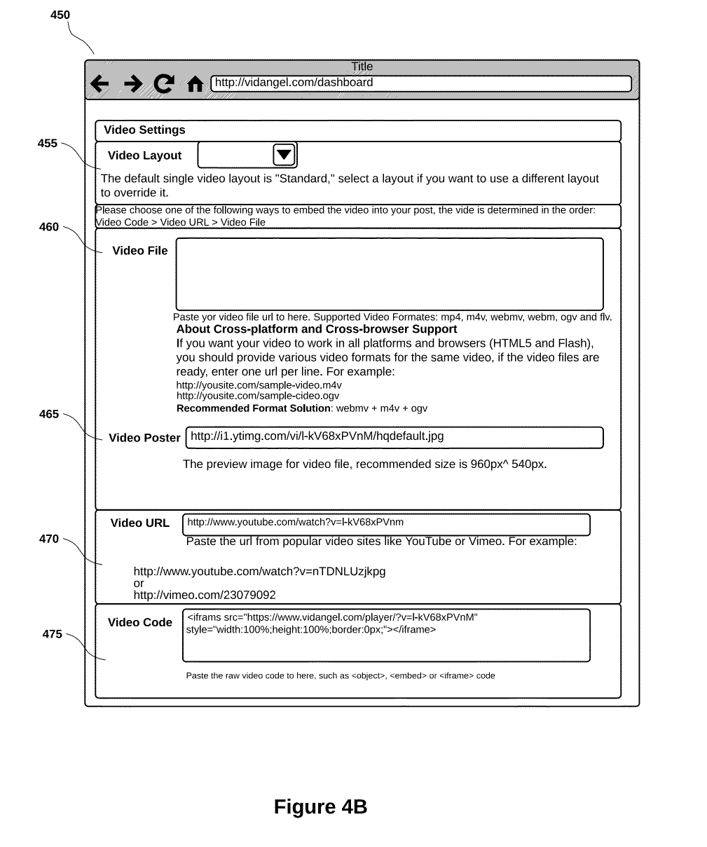

FIG. 4A illustrates an exemplary interface 400 of a dashboard showing audiovisual content waiting to be published. Entries 410, 420, 430, and 440 represent four movies, “Gladiator,” “The Matrix,” “Star Trek,” and “Lord of the Rings: The Fellowship of the Ring,” respectively, that are waiting to be published.

FIG. 4B illustrates an exemplary interface 450 for adding a file to the video catalog of the curation platform disclosed herein, or for editing the settings of the file. For example, using interface 455, a user may specify or edit the layout, e.g., “standard,” of a video file. Using interface 460, a user may specify or edit the URL for the source of a video file. Using interface 465, a user may provide or edit a URL or other identifying information for a preview image for a video. Using interface 470, a user may provide or edit a link to the movie from video sites such as YouTube™ or Vimeo™. Using interface 475, a user may provide or edit code for the video.

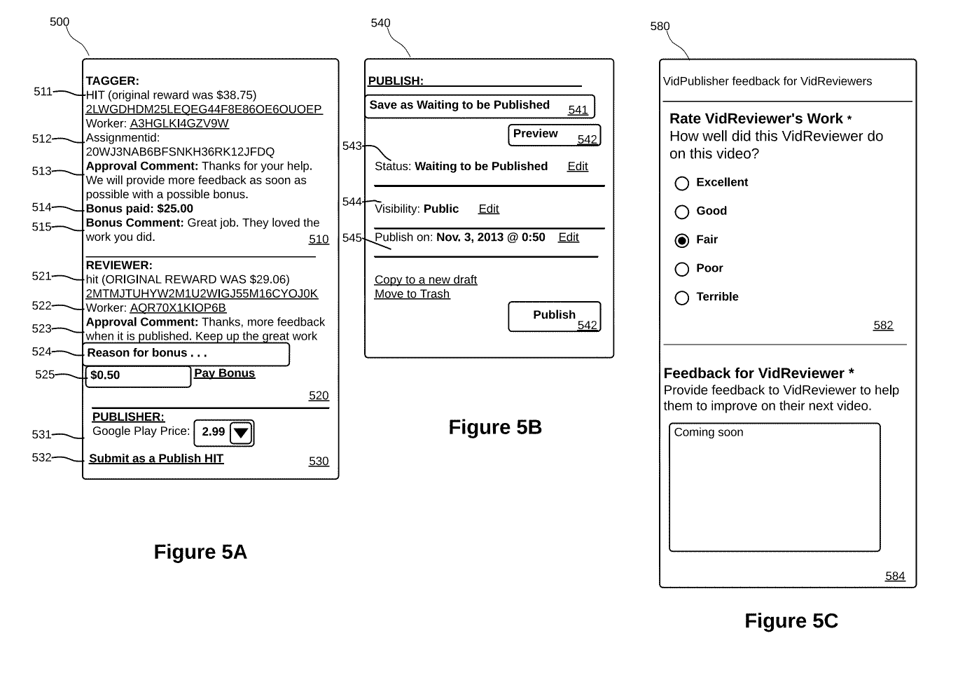

FIG. 5A illustrates an exemplary interface 500 associated with tagging, reviewing, and publishing. For example, “TAGGER” section 510 identifies, for a tagging job, the financial reward 511, worker id 512, approval comment 513, financial bonus 514, and bonus comment 515. “REVIEWER” section 520 identifies, for a reviewing job, the financial reward 521, the worker id 522, the approval comment 523, an interface 524 for entering a reason for a bonus, and an interface 525 for paying a bonus. “PUBLISHER” section 530 includes an interface 531 for setting a Google Play™ price and an option 532 for publishing.

FIG. 5B illustrates an exemplary interface 540 associated with publishing. For example, button 541 allows a user to save a video or video map as waiting to be published. Button 542 allows a user to preview a video or video map. Interface 543 indicates the status of a video, e.g., “waiting to be published,” and allows a user to edit this status. Interface 544 allows a user to determine the time at which a video or video map will be published. Button 542 allows a user to publish a video or video map.

FIG. 5C illustrates an exemplary interface 580 associated with reviewing the quality of tagging work. For example, a user may use interface 582 to rate, e.g., “Excellent” or “Good” or “Fair” or “Poor” or “Terrible,” a reviewer's work. A user may use interface 584 to provide feedback to a reviewer.

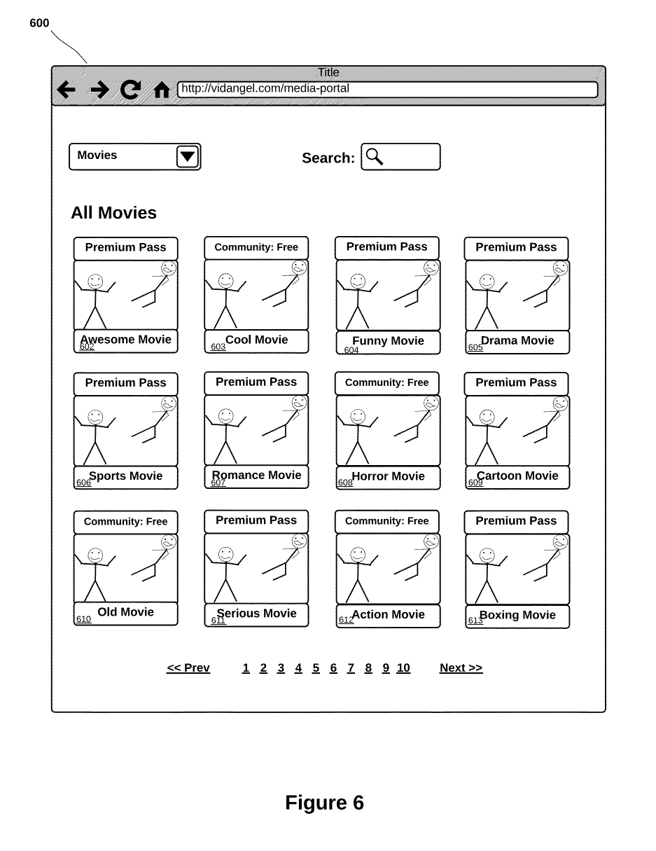

FIG. 6 illustrates an exemplary media portal interface 600 through which a user may, for example, select one of movies 602-613 for viewing.

Curation server 716 and media distribution server 722 may include one or more computing devices having data processing, storing, and communication capabilities. For example, these entities 716 and 722 may include one or more hardware servers, virtual servers, server arrays, storage devices and/or systems, etc., and/or may be centralized or distributed/cloud-based. In some implementations, entities 716 and/or 722 may include one or more virtual servers, which operate in a host server environment and access the physical hardware of the host server including, for example, a processor, memory, storage, network interfaces, etc., via an abstraction layer (e.g., a virtual machine manager).

In the depicted implementation, curation server 716 may include a curation engine 718 operable to curate video maps, tags, filters, facilitate collaboration between various stakeholders during the curation process, provide curation-related data (e.g., filters and video maps) to other entities of the system for use thereby to personalize playback of audiovisual content, provide users with a media portal providing access to media content, etc. Curation engine 718 may send data to and receive data from the other entities of the system, such as client devices 706, and media distribution server 722. It should be understood that curation server 716 is not limited to providing the above-noted acts and/or functionality and may include other network-accessible services. In addition, while a single curation server 716 is depicted in FIG. 7, it should be understood that one or more curation servers 716 may be included. In some embodiments, the curation server may also include a media portal 728a that provides the users with an interface via which the users may customize filters for audiovisual content and then play that audiovisual content, as discussed elsewhere herein.

FIG. 1C illustrates an embodiment of a curation platform including an extension module configured to extend the user application of the user (e.g., a web browser extension). The extension module, comprising buttons 170 and 171, may be configured to overlay a media player 165 with user-configurable options for use by a viewer to adjust filter settings and provide feedback. Interface buttons 170 and 171 in FIG. 1C illustrate such an overlay, in which a user may provide feedback for adjust a filter or tags.

In some embodiments, the platform may include various access levels, such as a community level and a premium level. The community level may be free to all users and the premium level may provide users access to premium content, video maps, parental controls, and filters in exchange for a payment, e.g., monthly or annual subscription fee.

A filter is a user-defined collection of one or more audio and/or video lineups. An audio lineup is a set of audio clips from a multimedia file (e.g., a movie) that are to be played during playback of the multimedia file by the media player. A video lineup is a set of video clips from the multimedia file that are to be played during playback of the multimedia file by the media player.

FIG. 1D is a graphical representation 190 of an example video lineup 192 and audio lineup 194 in an exemplary user-customized filter.

The clips included in the respective audio and video lineups for a given filter are selected based on the filter settings set by the system or a user. For instance, via a user interface a user may specify the type of content he wishes to exclude from the playback of a multimedia file, and the curation platform may select the clips to include in the respective lineups using the video tags associated with the video map for the multimedia file and the content settings specified by the user. As a further example, using toggles 110a-110j and 122a-122r, depicted in FIGS. 1A and 1B, respectively, a user may set what type of content to include or exclude from the multimedia file. Once complete, the user selects to watch the multimedia file and the user application provides the filter settings to curation engine 718 to generate the filter definition (e.g., audio and video lineups) by selecting clips matching the filter settings.

Each lineup, whether audio or video, may be comprised of data describing various sequences of clips from the multimedia file that match the filter settings. In some embodiments, each clip may be denoted by timecodes corresponding to start and end points of the clip.

During playback, the user application 708 configures the multimedia player to play back the multimedia file in a customized fashion based on the clips included in the audio and/or video lineups. More specifically, during playback of the multimedia file, the multimedia player renders audio for a given location in the multimedia file if that location corresponds to an audio clip in the audio lineup. In other words, the audio clips dictate which portions of the multimedia file are audibly played back. This results in the audio content between the audio clips not being rendered (e.g., being muted), and thereby implicitly eliminates the audio content the user does not want to hear.

Similarly, for video, during playback of the multimedia file, the multimedia player renders video for a given location in the multimedia file if that location corresponds to a video clip in the video lineup. In other words, the video clips dictate which portions of the multimedia file are visually played back. This results in the video content between the video clips not being rendered (e.g., being skipped, blanked, etc.), and thereby implicitly eliminates the video content the user does not want to see.

In some embodiments, the multimedia player determines whether a given location in the multimedia file being played back corresponds to an audio or video clip in lineups by comparing the timecode associated with the current playback location to the timecodes of the audio and video clips in the lineups of the filter.

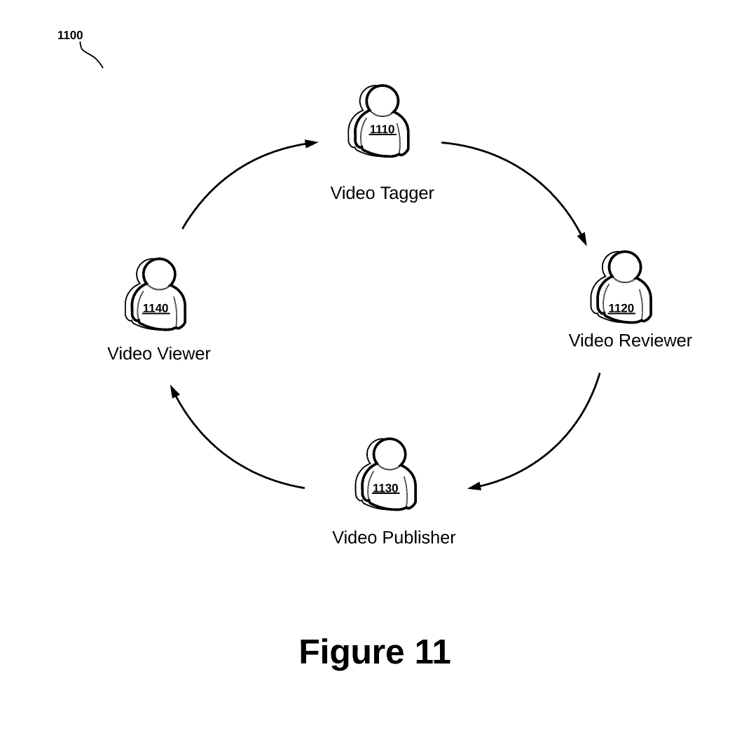

FIG. 11 illustrates one example of the possible iterative nature of the curation platform. In this example, a video tagger 1110 may define video tags for a video map, a video reviewer 1120 may review the tagged video map to ensure it correctly tags all potentially offensive and non-offensive content in the corresponding multimedia file, and a video publisher 1130 may finalize the video map and then publish it for use by a video viewer 1140. Video viewer 1140 may customize the filters for the multimedia file based on the video map and then watch the multimedia file using the filters and the video map to personalize the viewing experience to his/her tastes. Video viewer 1140 can provide feedback on the video map based on his/her viewing experience, and video tagger 1110, video reviewer 1120, and/or video publisher 1130 may incorporate that feedback to improve the video map.

It should be understood that in some embodiments, curation engine 718 may include instructions executable by processor 802 to automatically map and tag videos. For example, curation engine 718 may analyze a video (e.g., video data, audio data, etc.) for various patterns that match known patterns associated with certain types of content (objectionable, desirable, etc.) and may generate tags for the sections of the video corresponding to those patterns automatically and store them in association with a video map for that video. For instance, the analysis algorithms used to automatically generate tags may include known voice recognition and image recognition algorithms. When generating the tags, curation engine 718 may in some cases use the descriptors for the known patterns in the video tags to provide context. In some cases, the automatically-generated video tags may then be reviewed and published using the crowd-sourced curation process described herein. This is advantageous as it helps to ensure the accuracy of the automatically-generated tags. In some embodiments, curation engine 718 may monitor edits/inputs made during the curation process by the various different users, store tracking data for those edits/inputs, and then use the data to improve the accuracy of the video tags being generated. Curation engine 718 may use any known machine learning techniques for improving the automatic video map and tag generation process.

In some embodiments, the curation platform may be implemented using a web server (e.g., Apache), a MySQL database cluster, and a PHP interpreter, although it should be understood that any other suitable solution stack may be used. In some embodiments, the webserver may transmit formatted data files (e.g., HTML, XML, JSON), software objects (e.g., JavaScript objects), and presentation information (e.g., CSS style sheets), etc., to user application 708, and the user application may render these files to display the various interfaces discussed herein. In further embodiments, various information may be cached client-side, and user application 708 may refresh this data by requesting it from the other entities of system 700. Additional structure and functionality of curation engine 718 and media portal 728a are discussed further elsewhere herein.

Media distribution server 722 provides audiovisual content (e.g., multimedia files representing various movies, shows, amateur videos, etc.) stored in a data store to the other entities of system 700, such as one or more client devices 706. In some embodiments, media engine 724 included in media distribution server 722 includes software and/or hardware for cataloging and providing access to media content, such as audiovisual content, audio content, etc. In some embodiments, media engine 724 may include APIs for accessing the audiovisual content subscribed to, purchased by, bookmarked, etc., by a user. For instance, media portal 728a included in the curation server 716 may be capable of ingesting the audiovisual content associated with (e.g., rented by, purchased by, bookmarked by, etc.) various users to provide a customized portal through which the users may consume that audiovisual content.

Media distribution server 722 can cooperate with media portal 728 to provide an electronic resource to a user for consumption. As an example, media portal 728 may transmit a file (e.g., a webpage) to a client device 706 for display to user 712. The file may include code (e.g., an embedded HTML5, Flash, etc., media player) executable to receive an audiovisual content data stream from media engine 724 of media distribution server 722 and play it back to the user. In a further example, user application 708 may include a dedicated media player configured to receive and play content received from media distribution server 722. The audiovisual content may be stored as media objects in a media data store included in media distribution server 722, and transmitted to the one or more client devices 706 on demand, etc. Media distribution server 722 may be coupled to the media data store to access audiovisual content and other data stored in the media data store. In some embodiments, the audiovisual content may be streamed from media distribution server 722 via network 702. In other embodiments, a user can download an instance of the video and audio media objects from media distribution server 722 to a local repository for storage and local playback.

In some implementations, media portal 728, media engine 724, and/or curation engine 718 may require users 712 to be registered to access the functionality provided by them. For example, to access various functionality provided by media portal 728, media engine 724, and/or curation engine 718, a user 712 may be required to authenticate his/her identity (e.g., by confirming a valid electronic address). In some instances, these entities 728, 724, and/or 718 may interact with a federated identity server (not shown) to register/authenticate users 712. Once registered, these entities 728, 724, and/or 718 may require a user 712 seeking access to authenticate by inputting credentials in an associated user interface.

Additional acts, structure, and functionality of client devices 706, curation server 716, media distribution server 722, and their constituent components are described in further elsewhere herein.

It should be understood that system 700 in FIG. 7 is representative of an example curation system, and that a variety of different system environments and configurations are contemplated and are within the scope of the present disclosure. For instance, various functionality may be moved from a server to a client, or vice versa, and some implementations may include additional or fewer computing devices, services, and/or networks, and may implement various functionality client or server-side. Further, various entities of system 700 may be integrated into a single computing device or system or additional computing devices or systems, etc.

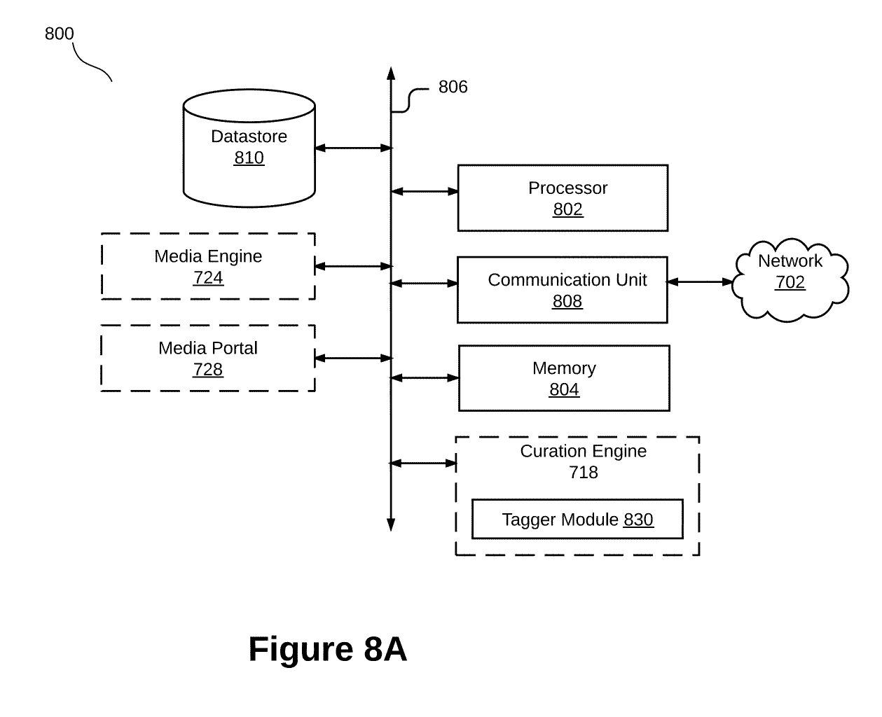

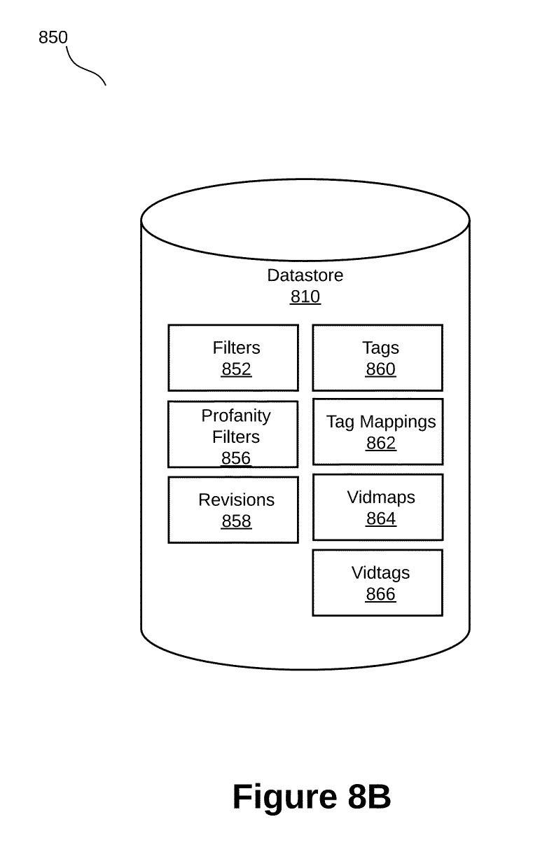

FIG. 8A is a block diagram of an example computing system 800, FIG. 8B is a block diagram of an example data store 810, and FIG. 9 is a block diagram of an example client device 706. The computing system depicted in FIG. 8A may be representative of a computing system and/or device(s) of curation server 716 and/or media distribution server 722. As depicted, computing system 800 may include a processor 802, a memory 804, a communication unit 808, and a data store 810, which may be communicatively coupled by a communications bus 806. The client device 706, as depicted in FIG. 9, may include a processor 802, a memory 804, a communication unit 808, a display 910, an input device 912, a sensor 914, and a capture device 916.

The computing system 800 depicted in FIG. 8A and client device 706 depicted in FIG. 9 are provided by way of example and it should be understood that they may take other forms and include additional or fewer components without departing from the scope of the present disclosure. For example, while not shown, computing system 800 may include input and output devices (e.g., a computer display, a keyboard and mouse, etc.), various operating systems, sensors, additional processors, and other physical configurations.

Processor 802 may execute software instructions by performing various input/output, logical, and/or mathematical operations. Processor 802 may have various computing architectures to process data signals including, for example, a complex instruction set computer (CISC) architecture, a reduced instruction set computer (RISC) architecture, and/or an architecture implementing a combination of instruction sets. Processor 802 may be physical and/or virtual, and may include a single core or plurality of processing units and/or cores. In some implementations, processor 802 may be capable of generating and providing electronic display signals to a display device, supporting the display of images, capturing and transmitting images, performing complex tasks including various types of feature extraction and sampling, etc. In some implementations, processor 802 may be coupled to memory 804 via bus 806 to access data and instructions therefrom and store data therein. In FIG. 8A, bus 806 may couple processor 802 to other components of server 722 including, for example, memory 804, communication unit 808, and datastore 810. In FIG. 9, bus 806 may couple processor 802 to other components of client device 706 including, for example, memory 804, communication unit 808, display 910, input device 912, sensor 914, and capture device 916.

Memory 804 may store and provide access to data to the other components of computing system 800 in FIG. 8A or client device 106 in FIG. 9. In some implementations, memory 804 may store instructions and/or data that may be executed by processor 802. For example, as depicted in FIG. 8A, memory 804 may store curation engine 718, media engine 724, and/or media portal 728 depending on the server configuration. Further, as depicted in FIG. 9, memory 804 may store operating system 918 and application 708. Memory 804 is also capable in various implementations of storing other instructions and data, including, for example, hardware drivers, other software applications, databases, etc. Memory 804 may be coupled to bus 806 for communication with processor 802 and the various other components depicted in FIGS. 8A and 9.

Memory 804 includes a non-transitory computer-usable (e.g., readable, writeable, etc.) medium, which can be an apparatus or device that can contain, store, communicate, propagate or transport instructions, data, computer programs, software, code, routines, etc., for processing by or in connection with processor 802. In some implementations, memory 804 may include one or more of volatile memory and non-volatile memory. For example, memory 804 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blu-ray™, etc.). It should be understood that memory 804 may be a single device or may include multiple types of devices and configurations.

Bus 806 can include a communication bus for transferring data between components of a computing device or between computing devices, a network bus system including network 702 or portions thereof, a processor mesh, a combination thereof, etc. In some implementations, curation engine 718, media engine 724, and/or media portal 728, and/or various other software operating on computing device 706 (e.g., an operating system, device drivers, etc.) may cooperate and communicate via a software communication mechanism implemented in association with bus 806. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

Communication unit 808 may include one or more interface devices (I/F) for wired and/or wireless connectivity with network 702. For instance, communication unit 808 may include, but is not limited to, CAT-type interfaces; wireless transceivers for sending and receiving signals using Wi-Fi™, Bluetooth®, cellular communications, etc.; USB interfaces; various combinations thereof; etc. Communication unit 808 may include radio transceivers (4 G, 3 G, 2 G, etc.) for communication with the mobile network 703, and radio transceivers for Wi-Fi™ and close-proximity (e.g., Bluetooth®, NFC, etc.) connectivity. Communication unit 808 may connect to and send/receive data via mobile network 703, a public IP network of network 702, a private IP network of network 702, etc. In some implementations, communication unit 808 can link processor 802 to network 702, which may in turn be coupled to other processing systems. Communication unit 808 can provide other connections to network 702 and to other entities of system 700 using various standard network communication protocols, including, for example, those discussed elsewhere herein.

Data store 810 is an information source for storing and providing access to data. In some implementations, data store 810 may be coupled to components 802, 804, and 808 of computing system 800 via bus 806 to receive and provide access to data. In some implementations, data store 810 may store data received from other elements of system 700 including, for example, media engine 724 and/or user application 708, and may provide data access to these entities.

Data store 810 may be included in computing system 800 or in another computing device and/or storage system distinct from but coupled to or accessible by computing system 800. Data store 810 can include one or more non-transitory computer-readable mediums for storing the data. In some implementations, data store 810 may be incorporated with memory 804 or may be distinct therefrom. In some implementations, data store 810 may include a database management system (DBMS) operable on computing system 800. For example, the DBMS could include a structured query language (SQL) DBMS, a NoSQL DMBS, or various combinations thereof, etc. In some instances, the DBMS may store data in multi-dimensional tables comprised of rows and columns, and manipulate, i.e., insert, query, update and/or delete, rows of data using programmatic operations.

With reference to FIG. 8B, an example data store 810 is shown. Data store 810 is configured to store and provide access to various data objects, such as filters 852, profanity filters 856, revisions 858, tags, 860, tag mappings 862, vidmaps 864, and vidtags 866, as discussed elsewhere herein.

With reference to FIG. 9, display 910 may display electronic images and data output by the client device 708 for presentation to a user 712. Display 910 may include any conventional display device, monitor or screen, including, for example, an organic light-emitting diode (OLED) display, a liquid crystal display (LCD), etc. In some implementations, display 910 may be a touch-screen display capable of receiving input from one or more fingers of a user 712. For example, display 910 may be a capacitive touch-screen display capable of detecting and interpreting multiple points of contact with the display surface. In some implementations, client device 706 may include a graphics adapter (not shown) for rendering and outputting the images and data for presentation on display 910. The graphics adapter (not shown) may be a separate processing device including a separate processor and memory (not shown) or may be integrated with processor 802 and memory 804.

Input device 912 may include any device for inputting information into client device 706. In some implementations, input device 912 may include one or more peripheral devices. For example, input device 912 may include a keyboard (e.g., a QWERTY keyboard), a pointing device (e.g., a mouse or touchpad), a microphone, an image/video capture device (e.g., camera), etc. In some implementations, input device 912 may include a touch-screen display capable of receiving input from the one or more fingers of user 712. For instance, the functionality of input device 912 and display 910 may be integrated, and a user 712 of client device 706 may interact with client device 706 by contacting a surface of display 910 using one or more fingers. In this example, user 712 could interact with an emulated (i.e., virtual or soft) keyboard displayed on touch-screen display 910 by using fingers to contact the display in the keyboard regions.

The sensor 914 may include one or more sensing devices for detecting changes in the state of the client device 706 (e.g., movement, rotation, temperature, etc.). Example sensors may include, but are not limited to accelerometers, gyroscopes, thermocouples, etc. The sensor may be coupled to bus 806 to send the signals describing the changes it detects to the other components of client device 706, which can be used by them to provide various functionality and information to user 712.

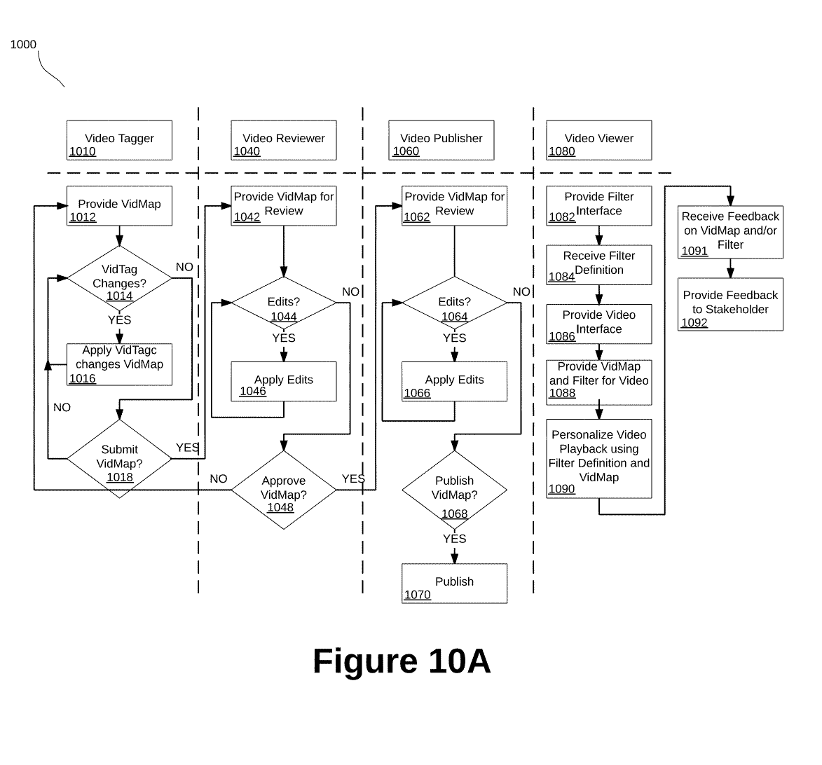

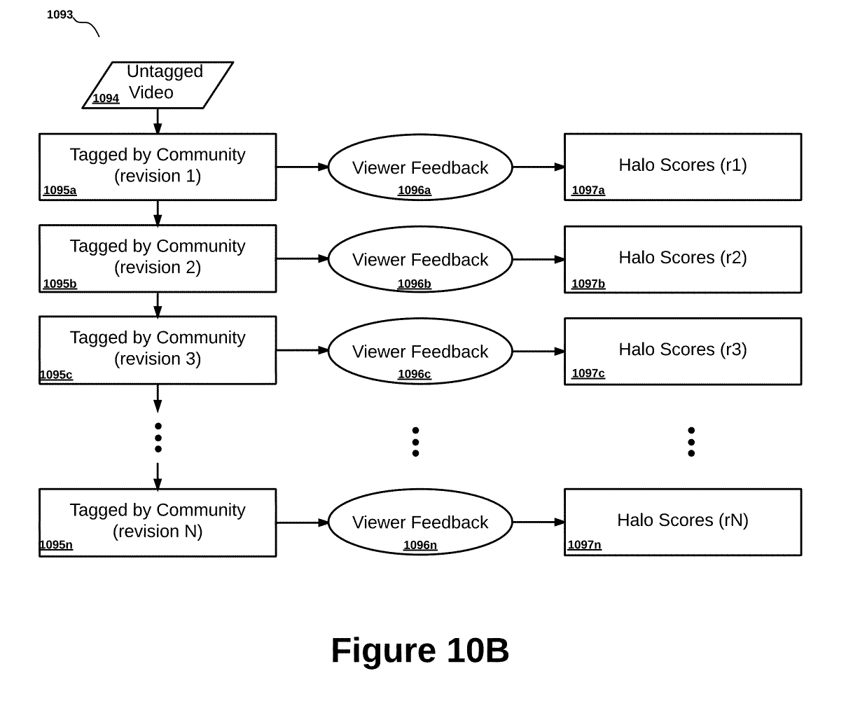

FIG. 10A includes a flowchart 1000 of an example curation process for curating premium content. In some embodiments, premium content may include paid content, such as content that is accessible only using a paid subscription or in exchange for a monetary payment, although it should be understood that this process could be applied to free content as well. As depicted, the curation process may be an iterative process between multiple stakeholders, such as video taggers, video reviewers, video publishers, and video viewers. Initially, a video tagger 1010 may request to customize a video map. At step 1012, video tagger 1010 interacts with curation engine 718 via an associated interface that includes options for adding tags to, editing existing tags of, and deleting tags from the video map. At steps 1014 and 1016, user application 708 may relay the changes (e.g., tag definitions, edits, deletions, etc.) to tagger module 830, which may apply those changes to a video map (e.g., by updating, inserting, deleting the corresponding video tag entries in the data store in association with the video map). Once video tagger 1010 has completed creating the tags for the video map, at step 1018 video tagger 1010 may submit the video map for review. In response, curation engine 118 may flag the video map as being ready for review in the data store (e.g., the data store 210).

In response, at step 1042 curation engine 118 may provide the video map to video reviewer 1040 for review. For instance, video reviewer 1040 may log into the curation platform and, upon doing so, may receive notification that the video map is ready for review, may search for and find the video map to be available for review, etc., and select to review the video map. At step 1044, while reviewing the video map, video reviewer 1040 may further configure the tags of the video map. For instance, video reviewer 1040 may correct any incorrect tags, input new tags, delete superfluous tags, etc., using a corresponding interface. User application 708 (e.g., see FIG. 1) may relay these tag edits to tagger module 830 (e.g., using asynchronous http requests), and at step 1046 the tagger module 830 may apply the edits to the video map. Once video reviewer 1040 is satisfied with the video map, video reviewer 1040 may, at step 1048, approve the video map using a corresponding user interface, and the curation module 718 may receive the approval from user application 708 and flag the video map as being ready for publishing.

Similar to video reviewer 1040, at steps 1062, 1064, and 1066, video publisher 1060 may log in and review and edit the video map, and once satisfied, publish the video map at step 1068 via an associated user interface. In response, user application 708 may transmit the publication request to curation engine 718, which may flag the video map as available for use by video viewers (e.g., via the media portal 728b).

At steps 1082-1090, video viewer 1080 may select to configure filters for a given multimedia file, and in response, media portal 728b may provide a filter interface for personalizing the playback of the multimedia file. To generate the interface, curation engine 718 may group the various tags of the video map by category, sub-category, language type, etc., and the interface may associate each group with a specific filter toggle and a set of user-selectable settings. Using the interface, the video viewer may define the settings associated with different groups of tags from the video map, customize one or more of the settings (e.g., by toggling the corresponding filters), and then save the filter definition via the interface. In response, user application 708 may transmit the filter definition to media portal 728b. In response, at step 1082, media portal 728b may provide a video interface that includes a media player (e.g., an embedded object representing the media player). At step 1088, the media portal 728b may also provide the video map associated with the multimedia file and the filter definition configured by the user. At step 1090, the media player may then personalize the playback of the audiovisual content based on the video map and the filter definition. Should the user have any feedback regarding the personalized playback experience (e.g., the video map, filter definition, etc.), the user may enter the feedback into the video interface in an associated field and submit that feedback to media portal 728b, which may at step 1091 receive and store the feedback in data store 810. At step 1092, curation engine 718 may then provide the feedback to the relevant stakeholder(s) (e.g., the video publisher), who may then incorporate it into the video map using the editing features thereof.

FIG. 10B illustrates a flowchart of an example curation process 1093 for curating community content. In some embodiments, community content may include free content, such as content freely available to the public without monetary payment, although it should be understood that this process could be applied to paid content as well. In contrast to the tagger-reviewer-publisher paradigm described with reference to FIG. 10A, the tagging process in FIG. 10B may be performed by members of a community. In some embodiments, the process may be open to an entire community. The community may be restricted or unrestricted. For instance, membership in the community may be open to any user having access to the Internet or may require registration and/or approval from a community administrator. Curation server 716 may include a community management software module executable by curation server 716 to manage community membership. Once a member of the community, any community member can tag a multimedia file or create a new revision of an already tagged multimedia file. Curation server 716 may receive revisions from client devices 706 of the community members and may store and maintain the revisions in a database (e.g., included in data store 810).

As shown in FIG. 10B, a user may watch a tagged or untagged community multimedia file via an associated user interface, and after watching the community multimedia file, at step 1096 may be presented a question by the interface asking about the quality of the video map for that particular multimedia file. The system (e.g., curation server 716 via the network 702) may collect this feedback and use it to produce a halo score 1097 for each video map. A halo score is a visual way for viewers to determine the quality of a video map at a glance. In an example, one halo represents a low halo score and five halos represents the highest possible halo score, although it should be understood that scores may be quantified or represented using other scales and values. In some embodiments, halo scores may be presented to the user along with representations of the multimedia files that are available for viewing (e.g., via a media portal). Curation engine 718 may include a scoring software module executable to determine the halo score. The scoring module may use various inputs to calculate a halo score for a given multimedia file, including feedback from viewers, the number of views a multimedia file has, the number of revisions the multimedia file has received from community members, etc.

In some embodiments, when a viewer watches a community multimedia file, curation engine 718 may be configured by default to provide the most recent version of the video map to customize playback of the video. In situations where the most recent revision causes the video map's halo score to decrease, curation engine 718 may revert back to providing the previous revision of the video map.

In some embodiments, once the score of a particular video map reaches a certain threshold (e.g., four halos or higher), any further revisions may be curated using a process the same as or similar to the process for curing premium content as described above in FIG. 10A. Under this process, all changes will need to be approved by a video reviewer and/or video publisher. This is advantageous as it helps to ensure that high-quality video maps are not negatively affected by a low-quality revision.

In some embodiments, to keep the various stakeholders engaged, the process may provide various incentives to the stakeholders to help ensure that the filters curated by them and provided to video viewers are of the highest quality. For instance, curation engine 718 may be capable of tracking the activity of the different stakeholders and giving them a predetermined amount of credit for the different functions that they perform when curating the video maps and filters. For instance, for every video tag that a video tagger adds to a video map, curation engine 718 may attribute X points to that video tagger (e.g., by storing a corresponding entry in the data store 810). In another example, for every valid video tag change that a reviewer makes, curation engine 718 may attribute Y points to that video tagger. After a given user accumulates a predetermined amount of points (e.g., 50,000), curation engine 718 may be configured to add an incentive to the user's account (e.g., a free video rental, premium subscription credit, etc.)

Curation engine 718 may also analyze the activity tracked by the various users (e.g., taggers, reviewers, publishers) to determine how much rework was required before successfully publishing the video maps for a multimedia file. For instance, curation engine 718 can quantify the accuracy of the initial tags created by the video tagger based on the number of changes the video reviewer and/or video publisher made. Similarly, curation engine 718 can quantify the accuracy of the review by the video reviewer by determining the number of changes that the video publisher had to subsequently make to the video map to ready it for publishing.

Curation engine 718 can also analyze user performance over time, over the publishing of numerous video maps, to determine a performance trend. In some cases, should the performance trend drop below a certain threshold, the user may be demoted to a more subordinate role or may be cut off from participating in the curation process. On the other hand, users who perform their roles well may be promoted to a more prestigious role (e.g., from video tagger to video reviewer, or video reviewer to video publisher).

In some cases, curation engine 718 may further base the performance analysis of its curators on the video viewer ratings of the multimedia files and/or demand for the multimedia files. If a given multimedia file consistently receives poor ratings and/or has low demand, then curation engine 718 may determine that creators, reviewers, and publishers of the tags of the video map associated with the multimedia file did a low-quality job in curating the tags and corresponding filters.

In some cases, the curators (e.g., video taggers, video reviewers, and video publishers) may earn a certain amount of money for each video map they curate. For instance, for premium content, $150 dollars may be collectively earned by the curators, and for community content, $110 dollars may be earned. Curation engine 718 may split up the amount based on the roles of the users. For instance, for each $110 dollar multimedia file, the video tagger may earn $60 dollars, the video reviewer may earn $30, and the video publisher may earn $10. However, curation engine 718 may adjust the monetary ratios downward or upward based on the actual contribution of the users. For instance, if, upon analyzing the activity of the various users, curation engine 718 determines that video tagger did not spend enough time creating the tags, and as a result, missed several tags that the video reviewer and the video publisher had to make up for, curation engine 718 may increase the portion paid to the video reviewer and video publisher and decrease the portion paid to the video tagger. In some embodiments, the multimedia file that was curated must receive a certain amount of traffic (e.g., must be streamed a certain number of times over a predetermined period of time), before curation engine 718 gives the curators credit for the work they did curating the video map for the multimedia file. This allows time to receive feedback from viewers and allows curation engine 718 to account for this feedback when allocating rewards to various curators.

The technology described herein can take the form of an entirely hardware implementation, an entirely software implementation, or implementations containing both hardware and software elements.

What is claimed is:

1. A method, comprising providing a platform configured to:
collect tagging information for content from one or more users and
provide tagging information for consuming the content in conjunction with a filter,
wherein the tagging information is generated by one or more users.

2. The method of claim 1, wherein consuming the content comprises applying the filter to the tagging information to determine which segments of the content should be skipped during playback.

3. The method of claim 1, wherein the tagging information comprises one or more tags, each tag identifying a segment of the content that contains filterable content.

4. The method of claim 3, wherein each tag comprises a start time and a stop time for a segment.

5. The method of claim 3, wherein each tag is associated with one or more filterable content categories.

6. The method of claim 5, wherein a filterable content category is one of Action, Dramatic, Scary, Alcohol/Drugs, Profane/Crude Language, Sex/Nudity, Violence, Negative Elements, and Positive Elements.

7. The method of claim 1, wherein content is one of audio content, visual content, or audiovisual content.

8. The method of claim 1, wherein:
the tagging information is generated by iteratively performing one or more of tagging, reviewing, and publishing;
tagging comprises generating a tag containing at least a start time and a stop time for a segment of the content;
reviewing comprises reviewing the quality of the one or more generated tags, determining whether improvement is necessary in the one or more generated tags, and, if such improvement is necessary, editing, creating, or deleting one or more tags;
publishing comprises making one or more of the generated tags available for consuming the content; and
the iterative generation of tagging information is performed, at least in part, by one or more users, each of whom may perform all or part of any iteration of tagging, reviewing, or publishing.

9. The method of claim 2, wherein a filter comprises a set of one or more preferences, each preference indicating whether, when content is consumed, a particular category of content should be skipped or retained.

10. The method of claim 8, wherein generation of tagging information further comprises viewers providing feedback on the quality of tagging information used, in conjunction with a filter, to consume content.

11. A system, comprising:
a tagging information system configured to collect tagging information for content from one or more users and
a tagging distribution system configured to provide tagging information for consuming the content in conjunction with a filter,
wherein the tagging information is generated by one or more users.

12. The system of claim 11, wherein consuming the content comprises applying the filter to the tagging information to determine which segments of the content should be skipped during playback.

13. The system of claim 11, wherein the tagging information comprises one or more tags, each tag identifying a segment of the content that contains filterable content.

14. The system of claim 13, wherein each tag comprises a start time and a stop time for a segment.

15. The system of claim 13, wherein each tag is associated with one or more filterable content categories.

16. The system of claim 15, wherein a filterable content category is one of Action, Dramatic, Scary, Alcohol/Drugs, Profane/Crude Language, Sex/Nudity, Violence, Negative Elements, and Positive Elements.

17. The system of claim 11, wherein content is one of audio content, visual content, or audiovisual content.

18. The system of claim 11, wherein the collecting of tagging information for content from one or more users comprises collecting tagging information wherein:
the tagging information is generated by iteratively performing one or more of tagging, reviewing, and publishing;
tagging comprises generating a tag containing at least a start time and a stop time for a segment of the content;
reviewing comprises reviewing the quality of the one or more generated tags, determining whether improvement is necessary in the one or more generated tags, and, if such improvement is necessary, editing, creating, or deleting one or more tags;
publishing comprises making one or more of the generated tags available for consuming the content; and
the iterative generation of tagging information is performed, at least in part, by one or more users, each of whom may perform all or part of any iteration of tagging, reviewing, or publishing.

19. The method of claim 12, wherein a filter comprises a set of one or more preferences, each preference indicating whether, when content is consumed, a particular category of content should be skipped or retained.

20. The method of claim 18, wherein generation of tagging information further comprises viewers providing feedback on the quality of tagging information used, in conjunction with a filter, to consume content.
